(19) United States
(12) Patent Application Publication
(10) Pub. No.: US 2005/0264835 A1
(43) Pub. Date: Dec. 1, 2005

(54) Tone control method

(75) Inventors: Satoshi Okita, Kyoto (JP); Satoru Kiyohara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/121,139

(22) Filed: May 4, 2005

(30) Foreign Application Priority Data
Jun. 1, 2004 (JP) 2004-162963

(51) Int. Cl. H04N 1/50; H04N 1/58

(52) U.S. Cl. 358/1.9; 358/504

(57) ABSTRACT

A tone control method for controlling tones of prints includes a control point selecting step for selecting, based on reference image data, a control point for use in controlling the tones of prints; a first obtaining step for obtaining information on an area around the control point in the reference image data as first area information; a second obtaining step for obtaining information on an area around a control point in the read image data, corresponding to the control point in the reference image data, as second area information; a determining step for determining whether the control points are proper, by comparing the first area information and second area information; and a tone control step for controlling the tones of the prints based on color information on the control points when the control points are determined proper in the determining step.

### BACKGROUND OF THE INVENTION

1. Field of the Invention

This invention relates to a tone control method for use in controlling ink feeding rates of a printing machine.

2. Description of the Related Art

In order to perform proper printing with a printing machine, it is necessary to control ink feeding rates properly. For controlling the ink feeding rates, it has been conventional practice to measure densities of control strips with a densitometer and determine from density data whether the ink feeding rates are proper or not. However, the density data from the control strips alone is not necessarily sufficient for attaining a proper color tone and the like for a picture area.

For this reason, a tone control method is used which provides control data for controlling the ink feeding rates of a printing machine. The control data is produced by comparing digitally created reference image data and image data of actual prints.

For example, calorimetric values or density values of colors (which are hereinafter collectively called “color values”) based on both image data are compared. Printing is considered proper when the color tone of an image actually printed substantially coincides with a reference color tone. At this time, it is difficult to attain an agreement in color tone and the like in all areas between the reference image and the image on the actual prints. For this reason, control points are selected from these images, and a comparison is made between the control point of the reference image data and the control point of the image data of the actual prints.

The control point is, for example, a representative point having a representative color that characterizes the image on the prints. This representative point is selected manually by the operator while observing the image. Alternatively, such a representative point may be determined automatically as in a print tone measuring apparatus disclosed in Japanese Unexamined Patent Publication No. 2004-50609.

However, in a precise sense, a disagreement may emerge between an image read from an actual print and a digitally created reference image. When, for example, platemaking data (with high resolution) is converted into a low resolution reference image by the nearest-neighbor method, a partial disagreement will occur between the image read from a print and the reference image. Although this is improved by converting resolution by the bicubic method, the read image may still be influenced by flare light in time of acquiring image. In this case also, a partial disagreement will occur between the read image and the reference image.

Further, a difference in resolution may cause a partial disagreement between the read image and the reference image. When, for example, image data of low resolution is used as reference image data in order to improve processing speed in determining a representative point automatically, an error due to an image deformation or the like may also cause a partial disagreement between the read image and reference image

A proper tone control is impossible when the read image and reference image are in partial disagreement and control points are selected from an area where the read image and reference image do not correspond.

### SUMMARY OF THE INVENTION

The object of this invention, therefore, is to provide a tone control method for enabling proper tone control to be carried out at all times, by determining whether control points are selected appropriately or not.

The above object is fulfilled, according to this invention, by a tone control method for controlling tones of prints by comparing read image data obtained by reading an image from a print and reference image data set in advance, one of the read image data and the reference image data being regarded as first image data, and the other as second image data, the method comprising a control point selecting step for selecting, based on the first image data, a control point for use in controlling the tones of prints; a first obtaining step for obtaining information on an area around the control point in the first image data as first area information; a second obtaining step for obtaining information on an area around a control point in the second image data, corresponding to the control point in the first image data, as second area information; a determining step for determining whether the control points are proper, by comparing the first area information and the second area information; and a tone control step for controlling the tones of the prints based on color information on the control points when the control points are determined proper in the determining step.

In a preferred embodiment, the control point selecting step is executed to select a plurality of control point candidates in order of priority, and when a candidate highest in the order of priority is determined improper in the determining step, the control point selecting step is executed again to select a candidate next highest in the order of priority as the control point for use in controlling the tones of the prints.

In another preferred embodiment, the first image data is data of lower resolution than the second image data.

In another aspect of the invention, a tone control method is provided for controlling tones of prints by comparing read image data obtained by reading an image from a print and reference image data set in advance, the method comprising a control point selecting step for selecting, based on the reference image data, a control point for use in controlling the tones of prints; a first obtaining step for obtaining information on an area around the control point in the reference image data as first area information; a second obtaining step for obtaining information on an area around a control point in the read image data, corresponding to the control point in the reference image data, as second area information; a determining step for determining whether the control points are proper, by comparing the first area information and the second area information; and a tone control step for controlling the tones of the prints based on color information on the control points when the control points are determined proper in the determining step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view of a color value measuring apparatus according to this invention;

FIG. 2 is a side view of the color value measuring apparatus;

FIG. 3 is a block diagram showing a principal structure of a control unit;

FIG. 4 is a flow chart of a tone control operation; and

FIG. 5 is an explanatory view showing a reference image displayed on a control panel, and control points determined.

### DESCRIPTION OF THE PREFERRED EMBODIMENTS

An embodiment of this invention will be described hereinafter with reference to the drawings. A color value measuring apparatus to which this invention is applied will be described first.

The embodiment described hereinafter discloses a color value measuring apparatus of the type that measures color values of images printed on sheets of printing paper sampled from a printing machine and placed on a table. This invention is equally applicable to a color value measuring apparatus of the type that measures color values of prints within a printing machine.

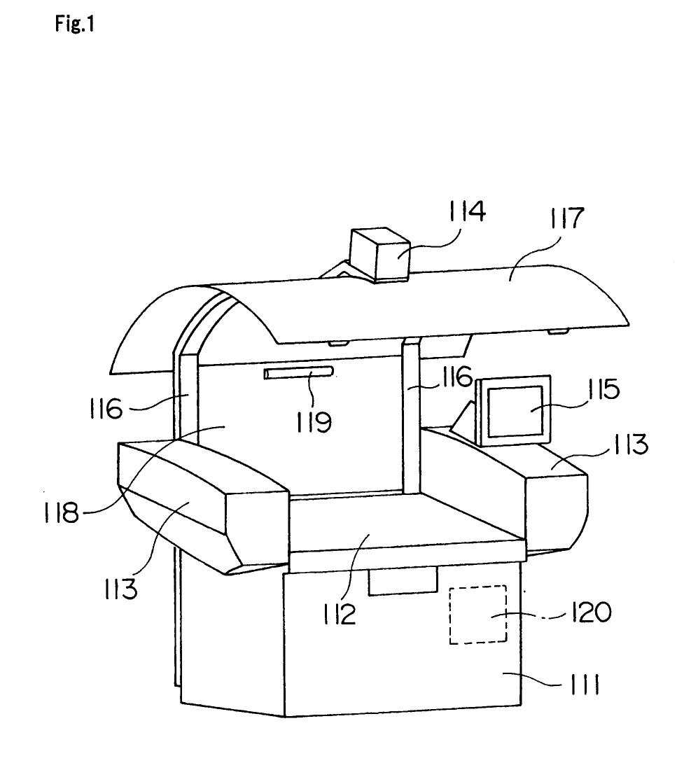

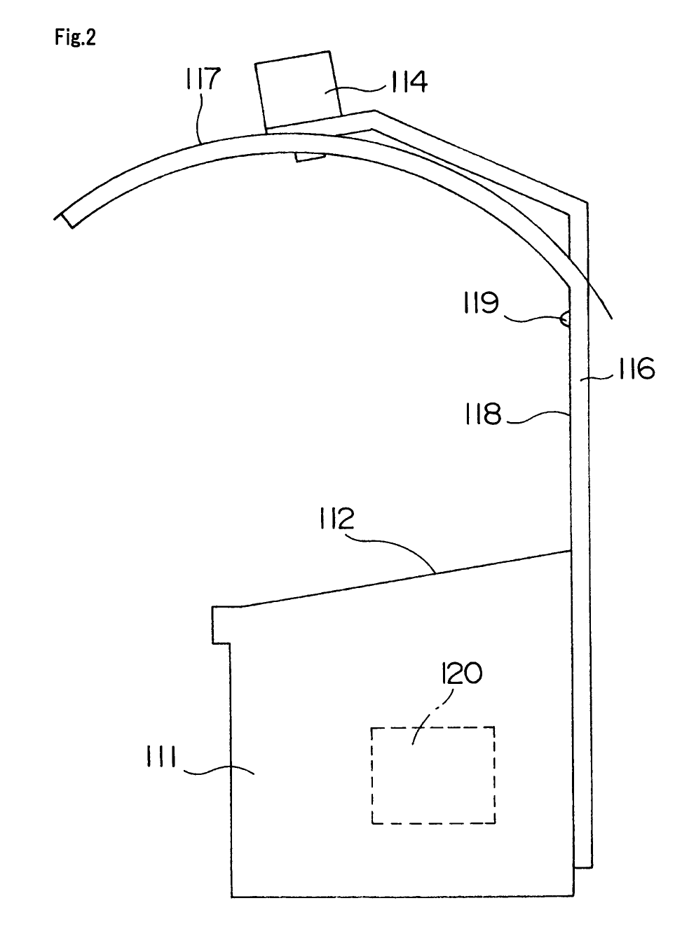

FIG. 1 is a perspective view of a color value measuring apparatus according to the invention. FIG. 2 is a side view of the apparatus. It is to be noted that light sources 113 and a control panel 115 are omitted from FIG. 2.

This color value measuring apparatus includes a table 112 disposed above a frame 111, a pair of light sources 113 arranged at right and left sides of the table 112, an image pickup unit 114 disposed above the table 112, a control panel 115 disposed above one of the light sources 113, an upper light-shielding plate 117 and a rear light-shielding plate 118 supported by a pair of posts 116, an auxiliary light source 119 attached to the rear light-shielding plate 118, and a control unit 120 mounted inside the frame 111 for controlling the entire apparatus.

The table 112 is shaped planar for receiving a print thereon. The table 112 has a surface in the form of a suction plate for holding the print by static electricity or vacuum suction. The surface of the table 112 is inclined about 10 degrees for facility of operation by the operator. The print held by suction on the inclined surface of the table 112 is illuminated by the pair of light sources 113 arranged at the opposite sides.

The image pickup unit 114 disposed above the table 112 has a digital camera for separating, with a dichroic mirror, light emitted from the light sources 113 and reflected from the surface of the print into the three primary color components of RGB, and receiving the individual components with separate CCD arrays. With this image pickup unit 114, RGB data can be obtained from the print. The RGB data is converted to YMCK data as necessary.

The control panel 115 is the touch panel type in the form of an LCD monitor having a pressure sensitive input function. This control panel 115 acts as both a display device and an input device, and is connected to the control unit 120 described hereinafter.

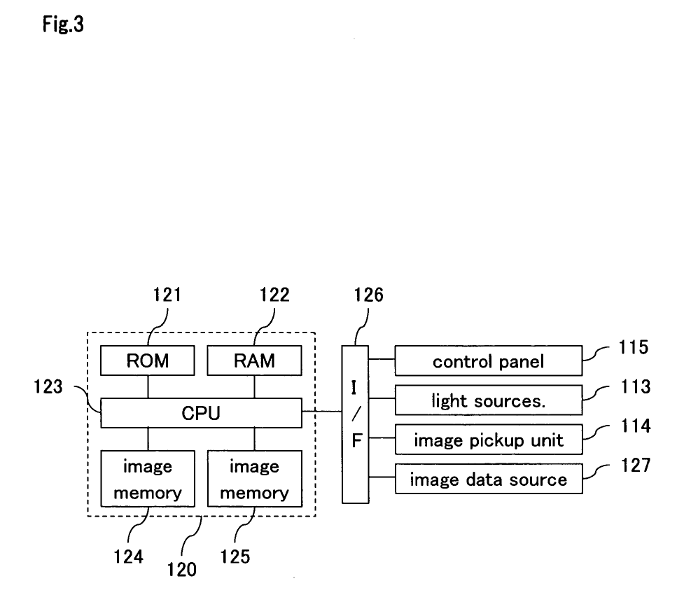

FIG. 3 is a block diagram showing a principal structure of the control unit 120.

This control unit 120 includes a ROM 121 for storing operating programs necessary for controlling the apparatus, a RAM 122 for temporarily storing data and the like during a control operation, a CPU 123 for performing logic operations, and a first and a second image memories 124 and 125. The control unit 120 is connected through an interface 126 to the control panel 115, light sources 113 and image pickup unit 114 noted above. The control unit 120 is connected also to an image data source 127 storing image data to be printed, such as a hard disk or an image processing device.

Referring again to FIGS. 1 and 2, the upper light-shielding plate 117 supported by the pair of posts 116 has a curved configuration extending in the fore and aft direction of the color value measuring apparatus. The light-shielding plate 117 is installed in order to intercept light, such as light from indoor light sources, that would constitute a regular reflection from the table 112. On the other hand, the rear light-shielding plate 118 supported between the pair of posts 116 serves to intercept light coming from behind the color value measuring apparatus.

The auxiliary light source 119 attached to the rear light-shielding plate 118 serves to compensate for a lack of light on the table 112 caused by the upper light-shielding plate 117 and rear light-shielding plate 118. The auxiliary light source 119 is in the form of a fluorescent light or the like, which is turned off when reading an image of a print with the image pickup unit 114.

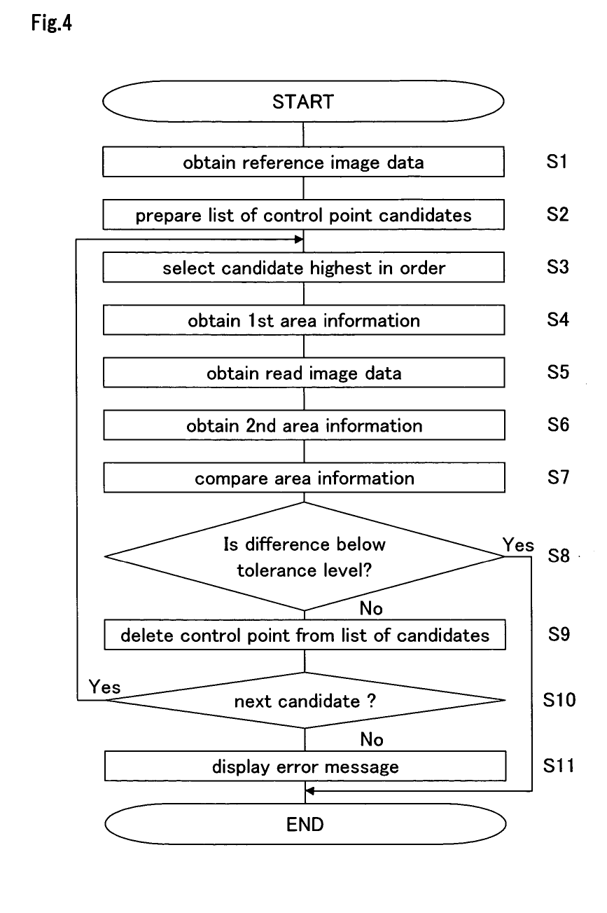

A tone control method using the color value measuring apparatus having the above construction will be described next. FIG. 4 is a flow chart of a tone control operation according to this invention.

In order to perform tone control with this color value measuring apparatus, reference image data is obtained first. The reference image data is stored in the first image memory 124 shown in FIG. 3. This reference image data is supplied from the image data source 127 shown in FIG. 4. The reference image data used is PPF (print production format) data of low resolution created digitally, for example. Alternatively, the reference image data is data of low capacity and low resolution created by using the above PPF data as original data, reducing the original data to one fourth, and reducing the tone of pixels to 1/16. It is also possible to use, as reference image data, image data read from reference paper (proof paper) created in advance, or a reduction of such image data.

Next, a list of control point candidates is prepared (step S2). Control points are representative points having colors characterizing the image of prints, for example. The control points are determined for the respective areas corresponding to the ink keys in the ink wells of the printing machine.

As described in the patent publication noted hereinbefore, the control points are determined automatically by using reference image data. In time of determining the control points, various setting conditions may be used, such as raising values of frequently used colors, raising values of colors close to a color set beforehand by the operator, and raising values at points where the density of YMC is high and the density of K is low. In this way, a list of control point candidates is prepared. In time of determining the control points, the method disclosed in Japanese Unexamined Patent Publication No. 2004-42517, for example, may be used.

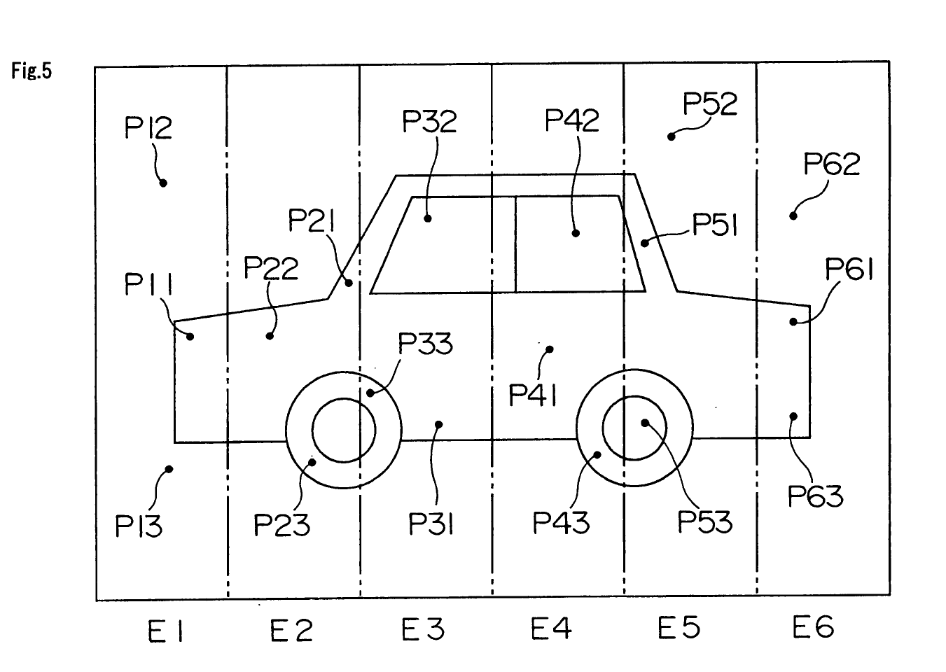

FIG. 5 is an explanatory view showing a reference image displayed on the control panel 115, and control points P11-P63 determined.

In this embodiment, the image is divided into six areas E1-E6 corresponding to the ink keys. Three control points are determined for each of the areas E1-E6. The control points P11-P63 are given an order of priority in each of the areas E1-E6. In this embodiment, each area includes only three control points for expediency of description. This is not limitative, but any number of control points may be set to each area, or different numbers of control points may be set to different areas.

Where the reference image data are image data of low resolution as noted hereinbefore, the control points P11-P63 may be determined automatically at high speed.

Next, the candidate highest in the order of priority is selected (step S3). That is, the point given the highest value is once selected as a control point, from the list of control point candidates prepared in advance.

Next, information on an area around the control point in the reference image data is obtained as first area information (step S4).

At this time, differences of pixel values of the area around the control point in the reference image data are calculated. That is, in calculating the differences, an average of the pixel values of nine pixels in three rows by three columns around the control point is calculated. Then, a total of differences between this average and the pixel values of 81 pixels in nine rows and nine columns around the control point (i.e. a sum of absolute values of the differences) is calculated. At this time, about 10% of pixel values with large deviations among the 81 pixel values are excluded from the calculation. The total value of the differences calculated in this way is stored as first area information in the RAM 122 shown in FIG. 3.

When obtaining information around the control point in the reference image data as first area information, distributions (standard deviations) of pixel values of the area around the control point in the reference image data may be used, instead of the differences of pixel values of the area around the control point in the reference image data noted above. In calculating the distributions, an average of the pixel values of nine pixels in three rows by three columns around the control point is calculated. Then, a total of squares of differences between this average and the pixel values of 81 pixels in nine rows and nine columns around the control point is calculated. At this time, about 10% of pixel values with large deviations among the 81 pixel values are excluded from the calculation. The total value of the squares of the differences calculated in this way is stored as first area information in the RAM 122 shown in FIG. 3.

Next, read image data is obtained (step S5). At this time, the image pickup device 114 reads image data from an actual print placed on the table 112. The read image data obtained by reading the image from the actual print is stored in the second image memory 125 shown in FIG. 3.

Next, information around a control point in this read image data is obtained as second area information (step S6). The control point in this read image data is located in a position corresponding to the control point in the reference image data described above.

At this time, as when the above-noted first area information is obtained, differences of pixel values of an area around the control point in the read image data are calculated. That is, in calculating these differences also, an average of the pixel values of nine pixels in three rows by three columns around the control point is calculated. Then, a total of differences between this average and the pixel values of 81 pixels in nine rows and nine columns around the control point (i.e. a sum of absolute values of the differences) is calculated. At this time, about 10% of pixel values with large deviations among the 81 pixel values are excluded from the calculation. The total value of the differences calculated in this way is stored as second area information in the RAM 122 shown in FIG. 3.

Also when obtaining information around the control point in the read image data as second area information, distributions (standard deviations) of pixel values of the area around the control point in the read image data may be used, instead of the differences of pixel values of the area around the control point in the read image data noted above. In calculating the distributions, an average of the pixel values of nine pixels in three rows by three columns around the control point is calculated. Then, a total of squares of differences between this average and the pixel values of 81 pixels in nine rows and nine columns around the control point is calculated. At this time, about 10% of pixel values with large deviations among the 81 pixel values are excluded from the calculation. The total value of the squares of the differences calculated in this way is stored as second area information in the RAM 122 shown in FIG. 3.

Next, the first area information and second area information are compared (step S7). When a difference between the first area information and second area information is below a tolerance level (step S8), the selected control point is determined to be in a proper area, and the operation is ended. In this case, color control is carried out by controlling the ink feeding rates and the like based on the color information on the control point currently selected. That is, propriety of the ink feeding rates and the like is determined by comparing color values of the control point in the reference image data and the color values of the control point in the read image data, and color control is carried out by controlling the ink feeding rates.

On the other hand, when the difference between the first area information and second area information exceeds the tolerance level (step S8), the selected control point is determined to be in an improper area, and this control point is deleted from the list of control point candidates (step S9).

When there is a next control point candidate (step S10), the operation returns to step S3 to select the next candidate as a control point once. Then, steps S4 through S7 are repeated. When the difference between the first area information and second area information is below the tolerance level (step S8), it is determined that a proper area has been selected for a corrected control point, and the operation is ended. Such an operation is repeated until a proper control point is selected.

However, when there is no next control point candidate (step S10) and none of the control point candidates have been determined proper, an error message is displayed (step S11), and the operation is ended.

In the embodiment described above, control points are determined by using the reference image data, and control points in the read image data are set to points corresponding to the control points in the reference image data. However, control points may be determined by using the read image data, with control points in the reference image data set to points corresponding to the control points in the read image data. In this case, control points may be determined first by using data of low resolution, which will realize a fast operation for selecting control points automatically.

In the embodiment described above, on the other hand, propriety of control points is determined successively, starting with the candidate highest in the order of priority in the list of control point candidates calculated automatically, and color tones are controlled based on one control point determined to be suitable. However, propriety of all or some of the control point candidates listed may be determined, and color tones may be controlled by using, as control points, all or some of the candidates determined proper. This is a method in which, for example, two or more control points are set to each of the areas corresponding to the ink keys, and color tones are controlled by using a combination of information on the respective control points. A technique using a plurality of control points in this way is disclosed in Japanese Patent Application No. 2004-116570 by the same applicant, for example. This technique determines a weight factor of each of control points, and combines information on the control points for use.

The embodiment described hereinbefore uses a list of a plurality of control point candidates calculated automatically. The operator may manually add control points to the control points in the list of candidates. In the above embodiment using a plurality of control points, the color tones of prints may be controlled based on a combination of a control point manually set by the operator and a control point determined proper by the automatic setting. Further, control points set manually may be added to the list of control point candidates, to have their propriety as control points determined.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-162963 filed in the Japanese Patent Office on Jun. 1, 2004, the entire disclosure of which is incorporated herein by reference.

1. A tone control method for controlling tones of prints by comparing read image data obtained by reading an image from a print and reference image data set in advance, one of said read image data and said reference image data being regarded as first image data, and the other as second image data, said method comprising:
a control point selecting step for selecting, based on said first image data, a control point for use in controlling the tones of prints;
a first obtaining step for obtaining information on an area around said control point in said first image data as first area information;
a second obtaining step for obtaining information on an area around a control point in said second image data, corresponding to said control point in said first image data, as second area information;
a determining step for determining whether said control points are proper, by comparing said first area information and said second area information; and
a tone control step for controlling the tones of said prints based on color information on said control points when said control points are determined proper in said determining step.

2. A tone control method as defined in claim 1, wherein said control point selecting step is executed to select a plurality of control point candidates in order of priority, and when a candidate highest in the order of priority is determined improper in the determining step, said control point selecting step is executed again to select a candidate next highest in the order of priority as the control point for use in controlling the tones of the prints.

3. A tone control method as defined in claim 1, wherein said first obtaining step is executed to obtain a sum of differences among pixel values in the area around said control point in said first image data as said first area information, and said second obtaining step is executed to obtain a sum of differences among pixel values in the area around said control point in said second image data as said second area information.

4. A tone control method as defined in claim 1, wherein said first obtaining step is executed to obtain distributions in the area around said control point in said first image data as said first area information, and said second obtaining step is executed to obtain distributions in the area around said control point in said second image data as said second area information.

5. A tone control method as defined in claim 1, wherein said first image data is data of lower resolution than said second image data.

6. A tone control method as defined in claim 5, wherein said control point selecting step is executed to select a plurality of control point candidates in order of priority, and when a candidate highest in the order of priority is determined improper in the determining step, said control point selecting step is executed again to select a candidate next highest in the order of priority as the control point for use in controlling the tones of the prints.

7. A tone control method as defined in claim 5, wherein said first obtaining step is executed to obtain a sum of differences among pixel values in the area around said control point in said first image data as said first area information, and said second obtaining step is executed to obtain a sum of differences among pixel values in the area around said control point in said second image data as said second area information.

8. A tone control method as defined in claim 5, wherein said first obtaining step is executed to obtain distributions in the area around said control point in said first image data as said first area information, and said second obtaining step is executed to obtain distributions in the area around said control point in said second image data as said second area information.

9. A tone control method for controlling tones of prints by comparing read image data obtained by reading an image from a print and reference image data set in advance, said method comprising:
a control point selecting step for selecting, based on said reference image data, a control point for use in controlling the tones of prints;
a first obtaining step for obtaining information on an area around said control point in said reference image data as first area information;
a second obtaining step for obtaining information on an area around a control point in said read image data, corresponding to said control point in said reference image data, as second area information;
a determining step for determining whether said control points are proper, by comparing said first area information and said second area information; and
a tone control step for controlling the tones of said prints based on color information on said control points when said control points are determined proper in said determining step.

10. A tone control method as defined in claim 9, wherein said control point selecting step is executed to select a plurality of control point candidates in order of priority, and when a candidate highest in the order of priority is determined improper in the determining step, said control point selecting step is executed again to select a candidate next highest in the order of priority as the control point for use in controlling the tones of the prints.

11. A tone control method as defined in claim 9, wherein said first obtaining step is executed to obtain a sum of differences among pixel values in the area around said control point in said reference image data as said first area information, and said second obtaining step is executed to obtain a sum of differences among pixel values in the area around said control point in said read image data as said second area information.

12. A tone control method as defined in claim 9, wherein said first obtaining step is executed to obtain distributions in the area around said control point in said reference image data as said first area information, and said second obtaining step is executed to obtain distributions in the area around said control point in said read image data as said second area information.

13. A tone control method as defined in claim 9, wherein said reference image data is data of lower resolution than said read image data.

14. A tone control method as defined in claim 13, wherein said control point selecting step is executed to select a plurality of control point candidates in order of priority, and when a candidate highest in the order of priority is determined improper in the determining step, said control point selecting step is executed again to select a candidate next highest in the order of priority as the control point for use in controlling the tones of the prints.

15. A tone control method as defined in claim 13, wherein said first obtaining step is executed to obtain a sum of differences among pixel values in the area around said control point in said reference image data as said first area information, and said second obtaining step is executed to obtain a sum of differences among pixel values in the area around said control point in said read image data as said second area information.

16. A tone control method as defined in claim 13, wherein said first obtaining step is executed to obtain distributions in the area around said control point in said reference image data as said first area information, and said second obtaining step is executed to obtain distributions in the area around said control point in said read image data as said second area information.
